(19) United States
(12) Patent Application Publication
(10) Pub. No.: US 2026/0105484 A1
(43) Pub. Date: Apr. 16, 2026

(54) CONNECTED DIGITAL EXPERIENCE VIA CROSS-CHANNEL INTELLIGENCE

(71) Applicant: AMERICAN EXPRESS TRAVEL RELATED SERVICES COMPANY, INC., New York, NY (US)

(72) Inventors: Dhayanand CHELLAPPA, New York, NY (US); Scott A. DELAUNE, New York, NY (US); Arvind SHARMA, New York, NY (US)

(73) Assignee: AMERICAN EXPRESS TRAVEL RELATED SERVICES COMPANY, INC., New York, NY (US)

(21) Appl. No.: 18/917,809

(22) Filed: Oct. 16, 2024

(51) Int. Cl. G06Q 30/0207

(52) U.S. Cl. CPC G06Q 30/0239

(57) ABSTRACT

Aspects disclosed provide systems and methods for connecting data across different content delivery channels (also referred to as channels herein) of a content delivery system, to improve data quality and to provide consistent experiences to users across the various channels. The system achieves this through the user a master identifier that connects/links data across different channels. By doing so it can give all the channels of the content delivery system insights into user/browser activities across channels.

### TECHNICAL FIELD

Aspects relate to content delivery channels, specifically content delivery channels that can be connected in a way to enable consistent digital content experiences across each of the content delivery channels.

### BACKGROUND

Websites and/or Internet platforms may present offers/promotions for products and services from various companies, businesses, merchants, etc. to users visiting the website. These offers/promotions may be pushed to user devices/browsers through various channels that the companies, businesses, merchants, etc. use to present such offers/promotions. For example, the offers/promotions may be presented via paid media, banner ads on websites, branded ads, direct e-mail offers, and/or mail-in offers, as a result of users consenting to receiving these offers/promotions. Each of these channels may have its own rules or policies to generate offers/promotions to users/browsers based on certain data each channel is able to obtain about the users/browsers.

As an example, a website of a financial institution, such as a credit card issuer, a bank, or a credit union, may deliver digital content to visiting user devices and offer various offers/promotions for products and services of the financial institution. The digital content can include offers for credit cards, loans, discounts or credits for opening accounts, and/or bonus points if the user applies for and is approved for a particular credit card. Often these promotions are generated using rules and policies that take into account user information obtained through various signals/data that are meant to tailor the offers to the user/browser. For example, these rules and policies can take into account user information obtained from cookies stored on a browser, that can indicate data such as, but not limited to, (1) what browser a user is using, (2) location information if available, (3) the type of device the browser is running on, (4) the IP address of the browser, or (5) any user provided information into the browser.

However, one issue is that websites and Internet platforms often provide disconnected and inconsistent offer/promotional experiences to user devices across the different channels that user devices visit. For example, a user may see different offers/promotions in a direct mail offer versus on websites versus on social media platforms. This is because the quality and types of data available to each of the channels varies greatly across the channels. Moreover, channels often do not share this data amongst each other and are typically siloed. This is for a variety of reasons, one of which being that the channels need to comply with data privacy regulations requiring the channels to secure and/or not share the data. As a result, channels are often unaware of user activities on other channels that may be useful when determining what offers best suit a user, resulting in the disconnected and inconsistent offer/promotional experiences. These disconnected and inconsistent offers/promotional experiences often leave users confused about what offers/promotions are available, and leaves open the question as to what offer/promotion is best suited to the user. Ideally, these offers/promotions should be the same or at least consistent across channels and should be tailored to users. Such consistency and customization helps reduce confusion and gives users better user experiences across channels. It also improves the quality of data across the channels and ultimately the content delivery channels.

The disconnected and inconsistent offers/promotional experiences also leads to other issues. For example, when users navigate across channels, they might not be able to find the same offers/promotions again if they navigate off the channel and onto another channel. For example, if a user navigates off a webpage and comes back to the webpage the offers/promotions presented to the user may be different. This leads to poor data quality and/or inconsistent user digital experiences.

Thus, systems and methods are needed to address this problem and to facilitate consistent experiences across channels and to improve data quality.

### SUMMARY

Aspects disclosed herein provide a system and methods for connecting data across different content delivery channels (also referred to as channels herein), to improve data quality and to provide consistent experiences to users across the various channels. Throughout this disclosure, channels refers to information transmission mediums for the transmission of multiple content formats, for example audio, video, and text. Channels can include direct e-mail, paid media, websites, or branded advertisements offered through third party platforms (e.g., social media platforms), or direct mail offers to physical addresses.

The system and methods improve conventional content delivery over media channels by implementing an architecture that connects data across often siloed channels using a common and persistent identifier (also referred to as a master identifier or master ID herein). In aspects, the master ID may be a data object, hashed value, alpha-numeric string, digital fingerprint, or a similar digital identifier, that maps a user and/or a particular browser across platforms. By connecting data from these channels through the master ID, the system seeks to obtain better data mapping across the channels to identify the same users/browsers across the channels.

In aspects, the system can implement one or more computing devices to perform the aforementioned functionality. In aspects, the one or more computing devices can achieve the aforementioned functionality by receiving from a channel, a channel identifier (channel ID) and associated channel ID data. The channel ID and associated channel ID data can identify a particular user and/or a particular browser and the user's/browser's activity on a particular channel. For example, the channel ID and the associated channel ID data can identify a particular browser on a channel, when the browser visited the channel, what promotions and/or offers were presented to the browser, and at what times. Often the channel ID is specific to the content delivery channel. That is, the channel ID is unique to the particular channel and is not used to identify the user and/or the particular browser in other content delivery channels, which can have their own channel IDs and associated channel ID data.

In aspects, once received, the system can determine whether the channel ID is linked to a master ID. The master ID refers to a unique persistent identifier that identifies a user and/or a browser across multiple content delivery channels. Thus, the master ID seeks to consolidate and/or unify the various channel IDs and associated channel ID data across the multiple content delivery channels in a persistent manner. In aspects, the system can make this determination based on generating a confidence score. The confidence score refers to a probability calculation that the channel ID and associated channel ID data is linked to the master ID and associated master ID data. Thus, by associating channel IDs and master IDs across channels, the master ID can serve as a connector of the various channel IDs. In aspects, the confidence score will be determined by an identity resolution service as will be explained further below.

In aspects, if the channel ID is determined to be linked to the master ID, by for example, the confidence score being above a certain threshold value, the system can update a database storing the master ID and associated master ID data to append the master ID and associated master ID data with the information obtained from the channel ID and the associated channel ID data. For example, the system can append the master ID and associated master ID data to reflect updated information about what offers/promotions where shown to the user/browser, at what dates and times those offers/promotions were shown, what geographic location the user/browser was browsing from, any user provided information, etc. In this way, the master ID and associated master ID data can continuously learn the browser's and/or user's behavior, viewing habits, content history, and the like, to provide a more robust understanding of the browser and/or user's browsing history over a period of time. The idea being that the system can, over time, develop a robust understanding of the user/browser, which may be collected, analyzed, and/or transmitted back to each of the channels so that the channels can use this information to provide more directed and targeted offers/promotions based on the data accumulated across the various channels for the same user/browser. In this way, all the channels can have similar and consolidated data related to the browser and/or user, thus increasing the quality of the data across the content delivery channels as a whole. In aspects, the findings can be extended to non-digital content delivery channels such as mail in offers. For example, if users/browsers are identified based on the information of the digital channels, and physical addresses can be tied to the identified user/browser, then non-digital content delivery channels can apply the cross-channel knowledge such that mail-in offers or similar offers can be based on the same offers shown on the digital content delivery channels.

In aspects, if the channel ID is determine to not be linked to the master ID, by for example, the confidence score being below a certain threshold value, the system can create a new master ID in the database and update the new master ID and associated new master ID data with the channel ID and associated channel ID data. In aspects, over time, the master ID and associated master ID data may be updated similarly to what was described previously. In aspects, the master ID and associated master ID data may be transmitted back to each channel similar to what was described previously.

In aspects, the receiving of the channel ID and associated channel ID data from a content delivery channel may be in real-time or as part of a batch process. Real-time refers to instances in which the channel ID and associated channel ID data are transmitted by the channel to the system instantaneously or within seconds or milliseconds of the browser and/or user activity on the channel. A batch process refers to instances where the channel ID and associated channel ID data are collected over a period of time, and the collected data is bundled and transmitted to the system at a predefined time.

Certain aspects have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

The accompanying drawings, which are incorporated herein and form a part of the specification, illustrate aspects of the present disclosure and, together with the description, further serve to explain the principles of the disclosure and to enable a person skilled in the art to make and use the aspects.

FIG. 1 is an example system for connecting data across different content delivery channels according to aspects.

FIG. 2 is an example method of operating the system according to aspects.

FIGS. 3A and 3B show an example user experience flow 300 of the system 100 according to aspects.

FIG. 4 is an example architecture of the components implementing the system according to aspects.

### DETAILED DESCRIPTION

Aspects disclosed herein provide a system and methods for connecting data across different content delivery channels to improve data quality and to provide consistent experiences to users across the various content delivery channels.

The system and methods improve conventional systems by implementing an architecture that connects data across often siloed channels using a master ID. By connecting data from these channels through the master ID, the architecture seeks to obtain a better data mapping across the channels to identify the same users/browsers. The system can use this master ID and associated master ID data to continuously learn browsing history of a particular user/browser. That information can then be fed back into the channels so that the channels can obtain a more robust understanding of the browser and/or user activity on other channels, which they otherwise would not have been aware of.

This type of cross-channel user/browser information is not available in conventional systems. Conventional media/content delivery channels often deliver content by typically having multiple siloed channels that produce offers/promotions based on their own rules or policies, but because they are siloed with respect to not being able to see user and/or browser data and behavior on other channels, these channels often formulate which promotions and/or offers they will show based on limited information and in a vacuum. Depending on how much data and/or the quality of data available to channels, the offers/promotions shown may be of mixed quality. The system disclosed herein seeks to remedy this deficiency and provide an architecture that increases data quality by cross-referencing data across channels so that offers better targeting users can be made. It also seeks to improve the quality of data on the content delivery channels.

The following aspects are described in sufficient detail to enable those skilled in the art to make and use the disclosure. It is to be understood that other aspects are evident based on the present disclosure, and that system, process, or mechanical changes may be made without departing from the scope of aspects of the present disclosure.

In the following description, numerous specific details are given to provide a thorough understanding of the disclosure. However, it will be apparent that the disclosure may be practiced without these specific details. In order to avoid obscuring an aspect of the present disclosure, some well-known circuits, system configurations, architectures, and process steps are not disclosed in detail.

The drawings showing aspects of the system are semi-diagrammatic, and not to scale. Some of the dimensions are for the clarity of presentation and are shown exaggerated in the drawing figures. Similarly, although the views in the drawings are for ease of description and generally show similar orientations, this depiction in the figures is arbitrary for the most part. Generally, the disclosure may be operated in any orientation.

The term “module” or “unit” referred to herein may include software, hardware, or a combination thereof in an aspect of the present disclosure in accordance with the context in which the term is used. For example, the software may be machine code, firmware, embedded code, or application software. Also, for example, the hardware may be circuitry, a processor, a special purpose computer, an integrated circuit, integrated circuit cores, or a combination thereof. Further, if a module or unit is written in the system or apparatus claim section below, the module or unit is deemed to include hardware circuitry for the purposes and the scope of the system or apparatus claims.

The terms “service” or “services” referred to herein can include a collection of modules or units. A collection of modules or units may be arranged, for example, in software or hardware libraries or development kits in an aspect of the present disclosure in accordance with the context in which the term is used. For example, the software or hardware libraries and development kits may be a suite of data and programming code, for example pre-written code, classes, routines, procedures, scripts, configuration data, or a combination thereof, that may be called directly or through an application programming interface to facilitate the execution of functions of the system.

The modules, units, or services in the following description of the aspects may be coupled to one another as described or as shown. The coupling may be direct or indirect, without or with intervening items between coupled modules, units, or services. The coupling may be by physical contact or by communication between modules, units, or services.

### System Overview and Function

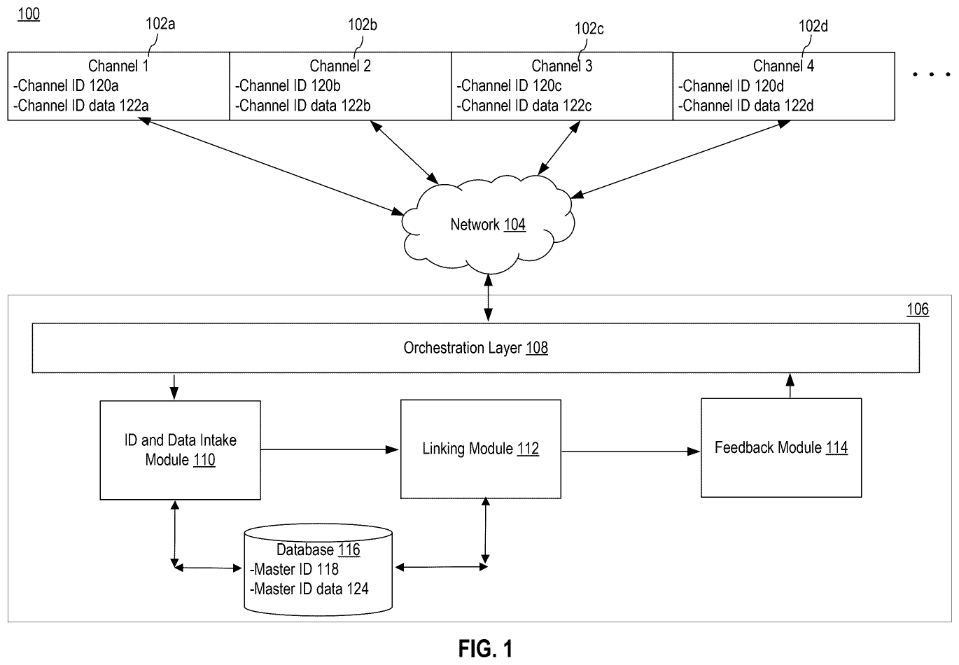

FIG. 1 is an example system 100 for connecting data across different content delivery channels 102, shown in FIG. 1 as {102a, 102b, 102c, 102d}, according to aspects. While only four channels are shown in FIG. 1, this is merely for convenience and simplicity. Any number of channels 102 or sub-channels of channels 102 can exist. As previously indicated, channels 102 refer to information transmission mediums for the transmission of multiple content formats, for example audio, video, and text. Channels 102 can include direct e-mail, paid media, website ads, branded advertisements offered through third party platforms (e.g., social media platforms), direct mail offers, etc. The aforementioned are exemplary and not meant to be limiting.

In aspects, each of the channels 102 can track user/browsers across the respective channel. For example, a user can browse a website. In FIG. 1, the website may be represented by channel 102a. If the user consents, a digital cookie or cookies may be installed on the user's browser while on channel 102a. In aspects, the cookies can track the user/browser as the user/browser navigates the channel 102a. In aspects, in order to track the user/browser, the cookies can be used to create a channel ID 120a. In aspects, the channel ID 120a can make a one-to-one association with the user/browser. In aspects, the channel ID 120a may be a data object, hashed value, alpha-numeric string, a digital fingerprint, or a similar digital identifier. A person of ordinary skill in the art will recognize other types of digital identifiers that may be used based on a reading of this disclosure.

Continuing with the example, in aspects, as the user browses the channel 102a, data may be collected, accumulated, and associated with the channel ID 120a. Such data will be referred to as channel ID data 122. FIG. 1 shows channel ID data 122 of various channels 102 as {122a, 122b, 122c, 122d}. The channel ID data 122 refers to information or data about the user, browser, or browser's activity on a particular channel. For example, the channel ID data 122a can identify user, browser, and/or browsing activity data as the user browses channel 102a. Such data can include a browser type and version number used by the user when browsing the channel 102a, information related to when the user/browser visited the channel 102a, what promotions and/or offers were presented to the user/browser, and at what times these promotions and/or offers were presented (via a timestamp associated with the promotion and/or offer). The channel ID data 122a can also log any user provided information that may be typed into the browser by the user while navigating the channel 102a. These examples are merely exemplary of the types of data that may be accumulated as the channel ID data 122a, and not meant to be limiting. In this way, the channel ID 120a and the channel ID data 122a can accumulate information on the user's browsing experience on the channel 102a. This can be done across all channels 102.

In aspects, once obtained, the channel IDs 120 and the associated channel ID data 122 may be transmitted to backend computing infrastructure, including a server infrastructure, of the system 100. This may be done via a network 104 that connects the backend computing infrastructure and the channels 102. The network 104 refers to a telecommunications network, such as a wired or wireless network. The network 104 can span and represent a variety of networks and network topologies. For example, the network 104 can include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 104. Cable, Ethernet, digital subscriber line (DSL), fiber optic lines, fiber to the home (FTTH), and plain old telephone service (POTS) are examples of wired communication that may be included in the network 104. Further, the network 104 can traverse a number of topologies and distances. For example, the network 104 can include a direct connection, personal area network (PAN), local area network (LAN), metropolitan area network (MAN), wide area network (WAN), or a combination thereof.

In aspects, the backend computing infrastructure of the system 100 may be housed in a cloud computing environment 106. The cloud computing environment 106 can include a server infrastructure. The cloud computing environment 106 may be a public or private cloud service. Examples of a public cloud include, without limitation, Amazon Web Services (AWS), IBM Cloud, Oracle Cloud Solutions, Microsoft Azure Cloud, and Google Cloud. A private cloud refers to a cloud environment similar to a public cloud with the exception that it is operated solely for a single organization.

In aspects, the cloud computing environment 106 can comprise a variety of centralized or decentralized computing devices. For example, the cloud computing environment 106 may include a mobile device, a laptop computer, a desktop computer, grid-computing resources, a virtualized computing resource, cloud computing resources, peer-to-peer distributed computing devices, a server, a server farm, or a combination thereof. The cloud computing environment 106 may be centralized in a single room, distributed across different rooms, distributed across different geographic locations, or embedded within the network 104.

In aspects, and as shown in FIG. 1, the computing devices of the cloud computing environment 106 may have various software modules or services stored thereon to enable the functions of the system 100. In aspects, these modules or services can include an orchestration layer 108, an ID and data intake module 110, a linking module 112, and a feedback module 114.

Continuing with the example, and in aspects, the channel IDs 120 (e.g., channel ID 120a) and the associated channel ID data 122 (e.g., channel ID data 122a) may be transmitted to the backend computing infrastructure, and received by the orchestration layer 108. The orchestration layer 108 refers to a service of the system 100 that can serve as an entry point for the channel IDs 120 and the associated channel ID data 122. The orchestration layer 108 can coordinate information transmission and retrieval between the channels 102 and the modules of the system 100. The orchestration layer 108 can also perform task allocations for the system 100. For example, the orchestration layer 108 can coordinate the real-time or batch processing between the channels 102 and the modules of the system 100 to receive the channel IDs 120 and the associated channel ID data 122. In aspects, the orchestration layer 108 can be coupled to the channels 102 via application programming interfaces (APIs) that help facilitate data transmission between the channels 102 and the orchestration layer 108. Similarly, the orchestration layer 108 can be coupled to the modules of the system 100 by APIs to help facilitate data transmission between the orchestration layer 108 and the modules.

In aspects, the orchestration layer 108 can forward the channel IDs 120 and the associated channel ID data 122 received to the ID and data intake module 110 for further processing. In aspects, the ID and data intake module 110 can determine whether the channel IDs 120 received are associated with/linked to any master ID 118 and associated master ID data 124 known by the system 100. This can be done in a variety of ways. In one aspect, the ID and data intake module 110 can determine a confidence score. As previously indicated, the confidence score refers to a probability calculation that a channel ID (e.g., channel ID 102a) is associated with/linked to a master ID 118 already known by the system 100.

The confidence score can be determined in a variety of ways. For example, the confidence score can be determined by comparing the channel IDs 120 and the channel ID data 122 to known master IDs (e.g., master ID 118) and associated master ID data 124 to determine a level of similarity between the two. For example, and in one aspect, the comparison can be done via a pairwise comparison between similar data elements. For example, ID values can be compared to one another, offer/promotion data can be compared to one another, and timestamp information can be compared to one another. In aspects, each of the values can be compared, and each time a matching pair is determined a score can be generated. Thus, the more similarity between the data fields, yields a higher score.

Once all the data elements are compared a final score can be determined. Once the final score is determined a level of confidence can be assigned to that score indicating that the system 100 has a high confidence that a given channel ID (e.g., channel ID 120a) is associated/linked to a known master ID 118. For example, if the final score is above a certain threshold value, the final score can be classified as a high confidence score. If on the other hand the final score is below a certain threshold value, the final score can be classified as a low confidence score.

In aspects, different fields of data can be given more or less weights than data fields during the score determination. For example, if a channel ID (e.g., channel ID 120a) is found to be associated with a master ID 118 already due to a prior association within the master ID data 124, channel ID 120a can be given a greater weight, and may even override other data fields because the ID and data intake module 110 can have a high certainty that the channel ID 102a is associated/linked to the master ID 118. Thus, the final score can be classified as a high confidence score, or a value can be assigned that is greater than the threshold value to automatically assign the final score to be a high confidence score.

In aspects, if the ID and data intake module 110 determines that the final score is a low confidence score, the ID and data intake module 110 can notify the database 116 and request that the database 116 generate a new master ID (similar to master ID 118) that can be linked/associated with the given channel ID (e.g., channel ID 120a). The new master ID can have associated new master ID data (similar to associated master ID data 124).

In aspects, once it is determined either way, whether the channel IDs 120 are associated/linked with a master ID 118 or not, the ID and data intake module 110 can pass control to the linking module 112 to consolidate the channel ID data 122 and the master ID data 124 of the channel IDs 120 and the master ID 118. The linking module 112 can execute computer-implemented logic and rules to perform the linking/association. In aspects, the linking module 112 can perform the linking/association by, for example, making database calls to append the master ID 118 and associated master ID data 124 with the information provided by the channel IDs 120 and associated channel ID data 122. For example, database 116 can have its rows and columns that store information related to the master ID 118 and the associated master ID data 124 be updated to reflect the new browsing related information reflected for the channel IDs 120 and the associated channel ID data 122. This can include updating what offers/promotions were shown to a given channel ID (e.g., channel ID 102a), at what time the offers/promotions were shown, what promotions/offers were made, etc. In this way, data can be accumulated across channels via the master ID 118 and associated master ID data 124, for the same users/browser, with the master ID 118 forming the association between the various channel IDs 120. In this way, the various channel IDs 120 can be determined to be linked together because if, for example, channel ID 102a is determined to be associated/linked to master ID 118 and channel ID 102c is also determined to be associated/linked to master ID 118, it can be determined that channel IDs 102a and 102c are also linked and likely to be the same user/browser. Once this connection is made, the consolidated data of both channel IDs 102a and 102c as reflected in the master ID data 124 can be transmitted to both channels 102a and 102c so that more information can be visible to each channel about the same user's/browser's experience on different channels 102.

In aspects, once the linking module 112 makes these connections and associations, the linking module 112 can pass control to the feedback module 114 to transmit the master ID data 124 back to the various channels 102. In aspects, the feedback module 114 can implement computer-implemented logic and rules to format the master ID data 124 in a form that can be understood by each of the channels 102. For example, each of the channels 102 may take in data in a different manner and in different formats. In aspects, the feedback module 114 can format the master ID data 124 in a form for each of the channels 102 so that it can be readily understood and processed by each of the channels 102. In aspects, the feedback module 114 can transmit the formatted master ID data 124 back to each of the channels via the orchestration layer 108, which can coordinate the sending and receiving of the master ID data 124.

The aforementioned system and process forms a system 100 that can continuously learn and feed its information back to the channels 102 that would otherwise not have information about other channels 102. This is highly valuable information for each of the channels 102 because they gain insights they otherwise would not have gotten through but for the system 100. The information obtained by each of the channels 102 can then be used to either consolidate offers/promotions, determine whether the correct offers/promotions are being shown to users/browsers, etc. Ultimately this has positive impacts on both the user experience across channels 102 because users/browsers will be shown more consistent offers/promotions regardless of what channel they are on. This also has a positive impact on and offers an improvement to the data quality of content delivery channels as a whole. Because more robust information can be obtained across channels 102 and a better picture of what is being shown across channels 102 to each individual channel, superfluous data or offers/promotions can be removed. The consolidation of data removes unnecessary processing of irrelevant offers/promotions and optimizes the delivery of relevant offers/promotions over time. Thus, improvements to content delivery channel scan be achieved by processing only relevant data and removing irrelevant data.

In aspects, the findings with respect to users/browsers can be extended to non-digital content delivery channels such as mail in offers. For example, if users/browsers are identified based on the information of the digital channels, and physical addresses can be tied to the identified user/browser, then non-digital content delivery channels can apply the cross-channel knowledge such that mail-in offers or similar offers can be based on the same offers shown on the digital content delivery channels.

The functions of the system 100 may be performed by the modules, units, or services, of the backend computing devices of the system 100, for example the computing devices of the cloud computing environment 106. The modules or services may be implemented as instructions stored on a non-transitory computer readable medium to be executed by one or more computing units such as a processor, a special purpose computer, an integrated circuit, integrated circuit cores, or a combination thereof. The non-transitory computer readable medium may be implemented with any number of memory units, such as a volatile memory, a nonvolatile memory, an internal memory, an external memory, or a combination thereof. The non-transitory computer readable medium may be integrated as a part of the system 100, or installed as a removable portion of the system 100.

### Methods of Operation

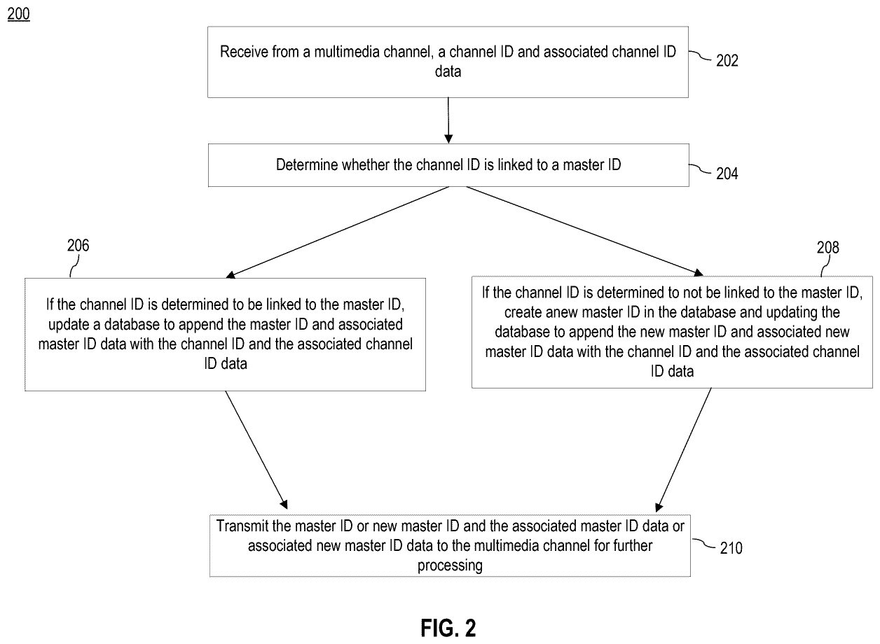

FIG. 2 is an example method 200 of operating the system 100 according to aspects. Method 200 can be implemented on computing devices, for example the computing devices of the cloud computing environment 106.

In aspects, method 200 can begin by receiving from one or more content delivery channels 102, a channel ID (e.g., channel ID 120a) and associated channel ID data 122 (e.g., channel ID data 122a), as shown in step 202. In aspect, receipt of the channel IDs 120 and associated channel ID data 122 can be coordinated by the orchestration layer 108.

In aspects, once received, the orchestration layer 108 can pass the channel IDs 120 and associated channel ID data 122 to the ID and data intake module 110 to determine whether each of the channel IDs 120 are linked to a master ID 118, as shown in step 204.

In aspects, if a channel ID (e.g., channel ID 120a) is determined to be linked to a master ID 118, the ID and data intake module 110 can make the association and pass control to the linking module 112 to append the master ID 118 and associated master ID data 124 with the data from the channel ID data (e.g., channel ID data 122a), as shown in step 206.

In aspects, if the channel ID (e.g., channel ID 120a) is determined to not be linked to a master ID 118, the ID and data intake module 110 can make a call to a database 116 to generate a new master ID (similar to master ID 118) and associated master ID data 124 and link the channel ID (e.g., 120a) and the associated channel ID data 122 (e.g., 122a) to the master ID 118 and associated master ID data 124. The ID and data intake module 110 can then pass control to the linking module 112 to append the master ID 118 and associated master ID data 124 with the data from the channel ID (e.g., channel ID 120a) and associated channel ID data 122 (e.g., channel ID 122a), as shown in step 208.

In aspects, once the channel IDs 120 and associated channel ID data 122 are linked, the master ID 118 and/or the associated master ID data 124 can be transmitted back to each of the channels 102 to give those channels 102 better insights as to the activity of a user/browser across the various channels 102, as shown in step 210. In aspects, the transmission can be coordinated by the orchestration layer 108.

The operation of method 200 is performed, for example, by system 100, in accordance with aspects described above.

### User Experience Flow of the System

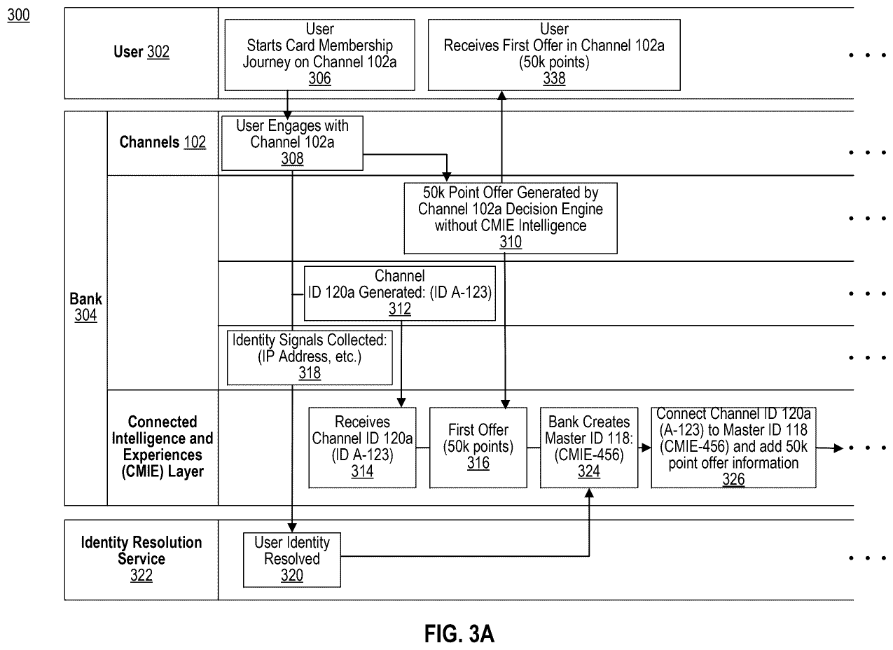

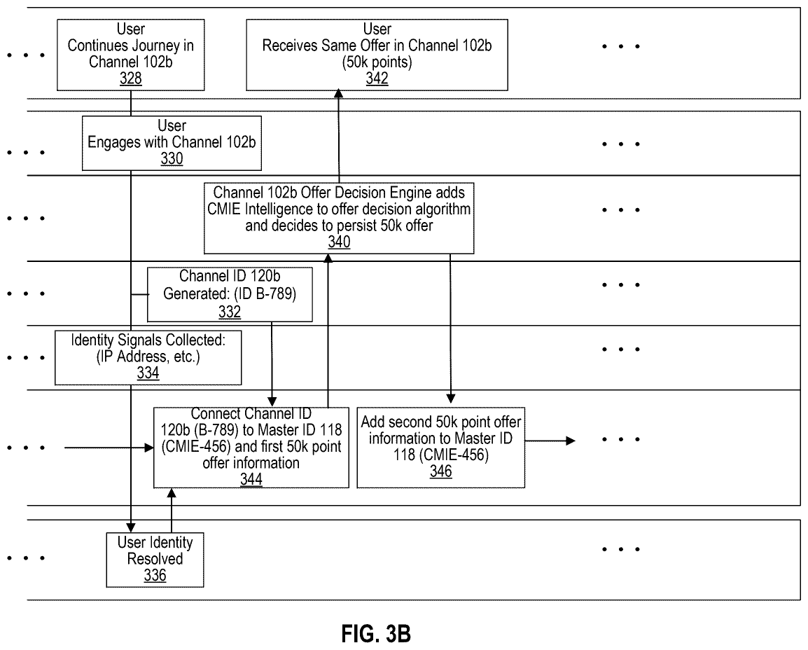

FIGS. 3A and 3B show an example user experience flow 300 of the system 100 according to aspects. The user experience flow 300 is an example of how the system 100 delivers consistent content experiences for users (e.g., user 302). With respect to FIG. 3, it is assumed that user 302 is visiting one or more content delivery channels 102 of a merchant or company, for example a bank 304. The bank 304 can push offers/promotions to the user 302 through the various channels 102. Using the system 100, the bank 304 can generate consistent offers/promotions across channels 102 for the user 302.

The example user experience flow 300 set forth in FIGS. 3A and 3B is meant to give but one example of how the system 100 can generate consistent offers/promotions to a user 302. However, the same user experience flow 300 can be achieved in other contexts in which users visit channels 102 of various merchants and/or businesses. These other merchants and/or businesses can be in other industries other than banking, such as consumer retail or e-commerce.

In aspects, the user experience flow 300 begins when the user 302 visits a specific content delivery channel (e.g., channel 102a) of the bank 304. This is shown by box 306. For the purposes of discussion, it is assumed that channel 102a is the bank's 304 website. In aspects, the user 302 can engage with the website, as shown by box 308. The user's 302 engagement can include, for example, browsing the various sub-pages of the website, clicking on links of the website, inputting data into fields on the website, etc.

In aspects, when the user 302 engages with the website, the channel 102a can begin tracking the user 302. In aspects, the channel 102a can generate a channel ID (e.g., channel ID 120a) to track the user 302. This is shown by box 312. In FIG. 3, the channel ID 120a is shown as “A-123.” This is exemplary and other identifiers can be used. In aspects, this channel ID 120a can be transmitted to the data intake module 110 to perform its functions as described with respect to FIGS. 1 and 2. This is shown by box 314.

Upon creation of the channel ID 120a, identity signals/data can be collected by the channel 102a regarding the user 302. These identity signals/data are meant to add identifying information to better identify the user 302. These signals/data can be used to better identify the user 302 across various other channels 102 (e.g., channel 102b, channel 102c, etc.). In aspects, the signals/data collected can include user information obtained from cookies downloaded and stored on a browser of a device of the user 302. The cookies can collect the signals/data as the user 302 engages and interacts with the website. Examples of signals/data that can be collected include, but are not limited to, information regarding, (1) what browser a user is using, (2) location information if available, (3) the type of device the browser is running on, (4) the IP address of the device, or (5) any user provided information into the browser. Other signals/data that are available can be used as will be understood by a person of ordinary skill in the art (POSA) reading this disclosure. This information can be stored as part of the channel ID data 122 (e.g., channel ID data 122a) of the user 302 and can later be transmitted along with the channel ID 120a to an identity resolution service 322, so that the identity resolution service 322 can further identify the user 302. Identity resolution services are known in the art and are typically third-party services used to identify data across data-points, platforms, or channels 102. A POSA reading this disclosure will recognize the different identity resolution services that can be used. Examples of identity resolution service providers include Axciom, AtData, LiveRamp, etc.

In aspects, the identity resolution service 322 can then proceed to resolve the user's 302 identity given the channel ID data 122a. Resolving the user's identity means to identify the user 302 either specifically or using a profile to give the general characteristics of the user 302. The identifying discussed does not necessarily mean that the user 302 is identified as a specific person, although that may be the case. Rather, identify the user means that the user 302 is identified as a unique user 302. This is shown by box 320. For the purposes of discussion with respect to FIG. 3, it is assumed that the identity resolution service 322 can resolve the user's 302 identity. The user's 302 identity can be appended to the channel ID data 122a.

In aspects, once the identity of the user 302 is resolved, the information including the channel ID 120a, and the associated channel ID data 122a can be transmitted to the ID and data intake module 110 as described with respect to FIGS. 1 and 2, so that the system 100 can build a user profile based on the channel ID 120a and associated channel ID data 122a. This can be done by generating a master ID 118 for the user 302. This is shown by box 324. In FIG. 3, the master ID 118 is shown as “CMIE-456.” Again, this is exemplary and any identifier can be used.

In aspects, based on or during the user's 302 engagement with the website, the user 302 can be shown offers/promotions for various products and/or services that the bank 304 offers. For the purposes of discussion with respect to FIGS. 3A and 3B, it is assumed that the offer/promotion shown to the user 302 is an offer/promotion for a bank 304 issued credit card. In aspects, the offer/promotion can be, for example, that the user 302 can earn 50,000 bonus points if he or she applies for and is approved for the credit card. This is shown by box 310.

In aspects, the offer/promotion can be pushed to the user 302 and displayed on the website through, for example, a banner ad or a graphic for the user 302 to view. This is shown by box 338.

In aspects, the channel 102a can track the offer/promotion shown to the user 302 as a part of the channel ID data 122a. In aspects, the channel ID data 122a can later be transmitted to the ID and data intake module 110 described with respect to FIGS. 1 and 2, via the network 104 and the orchestration layer 108. This is shown by box 316.

At this point, the system 100 has at least the information related to the user 302 as it relates to the user's interactions, offers/promotions shown, identity, etc. on channel 102a. The system 100 can then associate that information to the master ID 118 as a part of the master ID data 124 created for the user 302. This is shown by box 326.

It is assumed that at some point the user 302 will stop engaging with the website. In aspects, and at a later time after the user 302 has stopped engaging with channel 102a, the user 302 can find him or herself navigating to another one of the bank's 304 channels 102 (e.g., channel 102b). In aspects channel 102b can be, for example, a social media platform that the bank 304 uses to advertise its credit card offers/promotions. For the purposes of discussion with respect to FIGS. 3A and 3B, it is assumed that the user 302 visits another of the bank's 304 channels 102 (e.g., 102b). In aspects, the user 302 can begin his or her journey on channel 102b. This is shown by box 328 of FIG. 3B. It is important to note that channel 102b will have no prior knowledge of the user's 302 activity on channel 102a.

In aspects, the same flow of events as explained with respect to channel 102a can occur for the user 302 on channel 102b. For example, the user can engage with channel 102b, as shown by box 330. The channel 102b can then generate a channel ID (e.g., channel ID 120b) similar to what was described for channel 102a for the user 302, except the channel ID 120b is unique to the channel 102b. This is shown by box 332. The channel ID 120b is shown in FIG. 3B as “B-789.”This is exemplary.

In aspects, channel 102b can further collect signals/data for the user 302 on channel 102b based on the user 302 engagement and activities on channel 102b. This can be done in a similar manner to what was described with respect to channel 102a. This is shown by box 334. The signals/data can be saved as a part of the channel ID data 122b, similar to what was described with respect to channel 102a, as associated with channel ID 120b. In aspects, the channel ID 120b and associated channel ID data 122b can be transmitted to the identity resolution service 322 to resolve the identity of the user 302. This can be done similarly to how the identity resolution service 322 resolved the identity of the user 302 with respect to channel 102a. This is shown by box 336.

Assuming that the identity resolution service 322 resolves the identity of the user 302, in aspects, the identity resolution service 322 can transmit the information to the ID and data intake module 110. In aspects, once received, the ID and data intake module 110 can pass that information to the linking module 112 to link the user 302 identity determined based on the channel ID 120b and associated channel ID data 122b to the master ID 118 associated with the user 302. This is shown by box 344. As indicated previously the master ID 118 has as a part of its master ID data 124 that the 50,000 bonus point offer was shown to user 302 on channel 102a.

In aspects, the linking module 112 can attempt to link the channel ID 120b and associated channel ID data 122b with a master ID 118 by comparing the channel ID data 122b with master ID data 124 to see if there is a degree of similarity and determine a confidence score. In aspects, this can be done though the determination of the confidence score, as describe with respect to FIGS. 1 and 2.

For the purposes of discussion with respect to FIGS. 3A and 3B, we assume that the linking module 112 does determine that there is a high confidence that channel ID 120b is associated with master ID 118. As a consequence of this association, the channel ID 120a and associated channel ID data 122a can now be linked with channel ID 120b and associated channel ID data 122b via the master ID 118 and associated master ID data 124. As a result, channel 102b will now know what offers/promotions were shown to the user 302 on channel 102a. This includes the credit card offer to earn 50,000 bonus points if he or she applies for and is approved for the credit card. This is shown by box 344.

In aspects, based on this knowledge, channel 102b can generate the same offer/promotion and push it to the user 302. This is shown by box 340. The offer/promotion can be displayed to the user 302 on channel 102b, as shown by box 342. Finally, the fact that the 50,000 bonus point offer was shown in channel 102b can be stored as a part of the channel ID data 122b, and further appended to the master ID data 124. This is show by box 346.

In aspects, this process can proceed in the same manner for other channels 102 that the bank 304 uses (e.g., channel 102c, channel 102d, etc.), and the system 100 can link the various channel IDs 120 in the same manner to determine what offers/promotions to push to the user 302 across channels 102. In this way, the system 100 achieves its goal of generating consistent offers/promotions and increasing the quality of data across the system 100.

### Components of the System

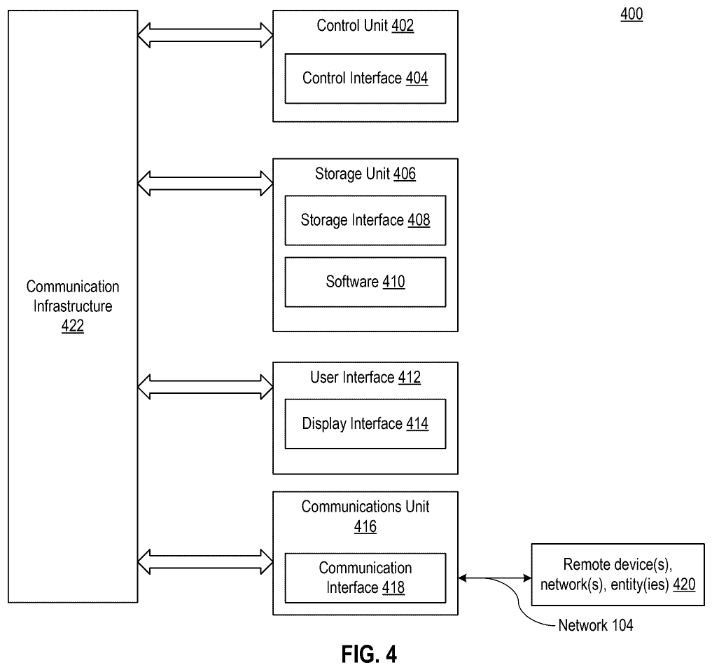

FIG. 4 is an example architecture 400 of the components implementing the system 100 according to aspects. The components may be implemented on any of the devices of the system 100, for example the computing devices of the cloud computing environment 106. In many aspects, the components may include a control unit 402, a storage unit 406, a communication unit 416, and a user interface 412. The control unit 402 may include a control interface 404. The control unit 402 may execute software 410 to provide some or all of the intelligence of system 100. The control unit 402 may be implemented in a number of different ways. For example, the control unit 402 may be a processor, an application specific integrated circuit (ASIC), an embedded processor, a microprocessor, a hardware control logic, a hardware finite state machine (FSM), a digital signal processor (DSP), a field programmable gate array (FPGA), or a combination thereof.

The control interface 404 may be used for communication between the control unit 402 and other functional units or devices of system 100. The control interface 404 may also be used for communication that is external to the functional units or devices of system 100. The control interface 404 may receive information from the functional units or devices of system 100, or from remote devices 420, or may transmit information to the functional units or devices of system 100, or to remote devices 420. The remote devices 420 refer to devices external to system 100.

The control interface 404 may be implemented in different ways and may include different implementations depending on which functional units or devices of system 100 or remote devices 420 are being interfaced with the control unit 402. For example, the control interface 404 may be implemented with integrated circuits, optical circuitry, waveguides, wireless circuitry, wireline circuitry to attach to a bus, an application programming interface (API), or a combination thereof. The control interface 404 may be connected to a communication infrastructure 422, such as a bus, to interface with the functional units or devices of system 100 or remote devices 420.

The storage unit 406 may store the software 410. For illustrative purposes, the storage unit 406 is shown as a single element, although it is understood that the storage unit 406 may be a distribution of storage elements. Also for illustrative purposes, the storage unit 406 is shown as a single hierarchy storage system, although it is understood that the storage unit 406 may be in a different configuration. For example, the storage unit 406 may be formed with different storage technologies forming a memory hierarchical system including different levels of caching, main memory, rotating media, or off-line storage. The storage unit 406 may be a volatile memory, a nonvolatile memory, an internal memory, an external memory, or a combination thereof. For example, the storage unit 406 may be a nonvolatile storage such as nonvolatile random access memory (NVRAM), Flash memory, disk storage, or a volatile storage such as static random access memory (SRAM) or dynamic random access memory (DRAM).

The storage unit 406 may include a storage interface 408. The storage interface 408 may be used for communication between the storage unit 406 and other functional units or devices of system 100. The storage interface 408 may also be used for communication that is external to system 100. The storage interface 408 may receive information from the other functional units or devices of system 100 or from remote devices 420, or may transmit information to the other functional units or devices of system 100 or to remote devices 420. The storage interface 408 may include different implementations depending on which functional units or devices of system 100 or remote devices 420 are being interfaced with the storage unit 406. The storage interface 408 may be implemented with technologies and techniques similar to the implementation of the control interface 404.

The communication unit 416 may enable communication to devices, components, modules, or units of system 100 or to remote devices 420. For example, the communication unit 416 may permit the system 100 to communicate between the channels 102 and the cloud computing environment 106. The communication unit 416 may further permit the devices of system 100 to communicate with remote devices 420 such as an attachment, a peripheral device, or a combination thereof through the network 104.

As previously indicated, the network 104 may span and represent a variety of networks and network topologies. For example, the network 104 may include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 104. Cable, Ethernet, digital subscriber line (DSL), fiber optic lines, fiber to the home (FTTH), and plain old telephone service (POTS) are examples of wired communication that may be included in the network 104. Further, the network 104 may traverse a number of network topologies and distances. For example, the network 104 may include direct connection, personal area network (PAN), local area network (LAN), metropolitan area network (MAN), wide area network (WAN), or a combination thereof.

The communication unit 416 may also function as a communication hub allowing system 100 to function as part of the network 104 and not be limited to be an end point or terminal unit to the network 104. The communication unit 416 may include active and passive components, such as microelectronics or an antenna, for interaction with the network 104.

The communication unit 416 may include a communication interface 418. The communication interface 418 may be used for communication between the communication unit 416 and other functional units or devices of system 100 or to remote devices 420. The communication interface 418 may receive information from the other functional units or devices of system 100, or from remote devices 420, or may transmit information to the other functional units or devices of the system 100 or to remote devices 420. The communication interface 418 may include different implementations depending on which functional units or devices are being interfaced with the communication unit 416. The communication interface 418 may be implemented with technologies and techniques similar to the implementation of the control interface 404.

The user interface 412 may present information generated by system 100. In many aspects, the user interface 412 allows a user to interface with the devices of system 100 or remote devices 420. The user interface 412 may include an input device and an output device. Examples of the input device of the user interface 412 may include a keypad, buttons, switches, touchpads, soft-keys, a keyboard, a mouse, or any combination thereof to provide data and communication inputs. Examples of the output device may include a display interface 414. The control unit 402 may operate the user interface 412 to present information generated by system 100. The control unit 402 may also execute the software 410 to present information generated by system 100, or to control other functional units of system 100. The display interface 414 may be any graphical user interface such as a display, a projector, a video screen, or any combination thereof.

The above detailed description and aspects of the disclosed system 100 are not intended to be exhaustive or to limit the disclosed system 100 to the precise form disclosed above. While specific examples for system 100 are described above for illustrative purposes, various equivalent modifications are possible within the scope of the disclosed system 100, as those skilled in the relevant art will recognize. For example, while processes and methods are presented in a given order, alternative implementations may perform routines having steps, or employ systems having processes or methods, in a different order, and some processes or methods may be deleted, moved, added, subdivided, combined, or modified to provide alternative or sub-combinations. Each of these processes or methods may be implemented in a variety of different ways. Also, while processes or methods are at times shown as being performed in series, these processes or blocks may instead be performed or implemented in parallel, or may be performed at different times.

The resulting methods and systems are cost-effective, highly versatile, and accurate, and may be implemented by adapting components for ready, efficient, and economical manufacturing, application, and utilization. Another important aspect of aspects of the present disclosure is that it valuably supports and services the historical trend of reducing costs, simplifying systems, and/or increasing performance.

These and other valuable aspects of the aspects of the present disclosure consequently further the state of the technology to at least the next level. While the disclosed aspects have been described as the best mode of implementing system 100, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense. Accordingly, the scope of the disclosure should be determined not by the aspects illustrated, but by the appended claims and their equivalents.

1. A computer-implemented method, comprising:
(a) receiving, through a telecommunications network by one or more computing devices and from a content delivery channel, a channel ID and associated channel ID data, wherein the channel ID is unique to the content delivery channel;
(b) determining, by the one or more computing devices, whether the channel ID and the channel ID data are linked to a master ID and master ID data stored in a database;
(c) if the channel ID is determined to be linked to the master ID, updating, by the one or more computing devices, a database to append the master ID with the channel ID and associated channel ID data, wherein the updating causes the database to execute a database operation that modifies the master ID data to reflect consolidated data;
(d) if the channel ID is determined to not be linked to the master ID, creating, by the one or more computing devices, a new master ID in the database and updating the database to append the new master ID and associated new master ID data with the channel ID and the associated channel ID data; and
(e) transmitting, through the telecommunications network by the one or more computing devices, the master ID or the new master ID and the associated master ID data or the associated new master ID data to the content delivery channel for further processing.

2. The computer-implemented method of claim 1, wherein (a) is performed in real-time or as a batch process.

3. The computer-implemented method of claim 1, wherein the associated channel ID data includes a promotional offer and a timestamp that the promotional offer was shown to a browser linked with the channel ID.

4. The computer-implemented method of claim 1, further comprising:
repeating, by the one or more computing devices, (a)-(d) for further content delivery channels; and
transmitting, by the one or more computing devices, the master ID or the new master ID and the associated master ID data or new master ID data to the further content delivery channels for further processing.

5. The computer-implemented method of claim 4, wherein the associated channel ID data for each of the further content delivery channels includes a promotional offer and a timestamp that the promotional offer was shown to a browser linked with each channel ID of the further content delivery channels.

6. The computer-implemented method of claim 5, further comprising generating, by the one or more computing devices, a confidence score indicating a confidence that each channel ID for each of the further content delivery channels is linked to the browser.

7. The computer-implemented method of claim 1, wherein the computer-implemented method is implemented in a cloud computing environment.

8. A non-transitory computer readable medium storing instructions, that when executed by one or more processors of a computing system, cause the computing system to perform operations comprising:
(a) receiving, through a telecommunications network and from a content delivery channel, a channel ID and associated channel ID data, wherein the channel ID is unique to the content delivery channel;
(b) determining, by the one or more processors, whether the channel ID and the associated channel ID data are linked to a master ID and master ID data stored in a database;
(c) if the channel ID is determined to be linked to the master ID, updating, by the one or more processors, a database to append the master ID with the channel ID and associated channel ID data, wherein updating causes the database to execute a database operation that modifies the master ID data to reflect consolidated data;
(d) if the channel ID is determined to not be linked to the master ID, creating a new master ID in the database and updating the database to append the new master ID and associated new master ID data with the channel ID and the associated channel ID data; and
(e) transmitting, through the telecommunications network and by the one or more processors, the master ID or the new master ID and the associated master ID data or the associated new master ID data to the content delivery channel for further processing.

9. The non-transitory computer readable medium of claim 8, wherein (a) is performed in real-time or as a batch process.

10. The non-transitory computer readable medium of claim 8, wherein the associated channel ID data includes a promotional offer and a timestamp that the promotional offer was shown to a browser linked with the channel ID.

11. The non-transitory computer readable medium of claim 8, wherein the operations further comprise:
repeating (a)-(d) for further content delivery channels; and
transmitting the master ID and the associated master ID data to the further content delivery channels for further processing.

12. The non-transitory computer readable medium of claim 11, wherein the associated channel ID data for each of the further content delivery channels includes a promotional offer and a timestamp that the promotional offer was shown to a browser linked with each channel ID of the further content delivery channels.

13. The non-transitory computer readable medium of claim 12, wherein the operations further comprise generating a confidence score indicating a confidence that each channel ID for each of the further content delivery channels is linked to the browser.

14. The non-transitory computer readable medium of claim 8, wherein the computing system is implemented in a cloud computing environment.

15. A computing system comprising:
a memory storing instructions;
one or more processors, coupled to the memory and configured to process the stored instructions to:
(a) receive, from a content delivery channel, a channel ID and associated channel ID data, wherein the channel ID is unique to the content delivery channel;
(b) determine whether the channel ID and the associated channel ID data are linked to a master ID and master ID data stored in a database;
(c) if the channel ID is determined to be linked to the master ID, update, by the one or more processors, a database to append the master ID with the channel ID and associated channel ID data, wherein the updating causes the database to execute a database operation that modifies the master ID data to reflect consolidated data;
(d) if the channel ID is determined to not be linked to the master ID, create a new master ID in the database and update the database to append the master ID and associated new master ID data with the channel ID and the associated channel ID data; and
(e) transmit, through the telecommunications network, the master ID or the new master ID and the associated master ID data or the associated new master ID data to the content delivery channel for further processing.

16. The computing system of claim 15, wherein (a) is performed in real-time or as a batch process.

17. The computing system of claim 15, wherein the associated channel ID data includes a promotional offer and a timestamp that the promotional offer was shown to a browser linked with the channel ID.

18. The computing system of claim 15, wherein the one or more processors are further configured to:
repeat (a)-(d) for further content delivery channels; and
transmit the master ID and the associated master ID data to the further content delivery channels for further processing.

19. The computing system of claim 18, wherein the associated channel ID data for each of the further content delivery channels includes a promotional offer and a timestamp that the promotional offer was shown to a browser linked with each channel ID of the further content delivery channels.

20. The computing system of claim 19, wherein the one or more processors are further configured to generate a confidence score indicating a confidence that each channel ID for each of the further content delivery channels is linked to the browser.
